(19) United States
(12) Patent Application Publication
(10) Pub. No.: US 2014/0281606 A1
(43) Pub. Date: Sep. 18, 2014

(54) DATA STORAGE POWER CONSUMPTION THRESHOLD

(71) Applicant: Silicon Graphics International Corp., Milpitas, CA (US)

(72) Inventors: Lance MacKimmie Evans, Boulder, CO (US); Gera Kazakov, Longmont, CO (US)

(73) Assignee: Silicon Graphics International Corp., Milpitas, CA (US)

(21) Appl. No.: 13/838,443

(22) Filed: Mar. 15, 2013

(51) Int. Cl. G06F 1/32; G06F 9/48

(52) U.S. Cl. CPC G06F 1/3268; G06F 9/4893
USPC 713/320

(57) ABSTRACT

A power consumption threshold is implemented to manage power consumed by a plurality of devices. A power consumption threshold may be selected for a data storage system having multiple drives. Policies may control operation of storage devices such as hard disk drives to ensure the power consumption threshold is not exceeded. The policies may implement procedures for scheduling hard disk drive operations based on disk drive power characteristics, scheduling maintenance tasks, managing device power states, and strategically scheduling device operations based on their current state. The policies may be implemented by a data manager application in communication with multiple tiers of a data storage system.

### BACKGROUND OF THE INVENTION

1. Field of the Invention

The presently claimed invention relates to system power saving techniques. More specifically, the claimed invention relates to managing power consumption in a data storage system.

2. Description of the Related Art

As companies create and utilize more data, the need for cost-effective data storage solutions has increased. Most data centers include massive quantities of rack mount storage systems. Each mounted storage system includes large numbers of storage devices. The storage devices typically include spin-up devices such as hard disk drives.

Hard disk drives may provide fast access to data, but consume more power than other types of storage devices. For data centers having hundreds or thousands of hard disk drive devices, the power consumption is significant. The hard disk drives, consume energy, whether they are being accessed or not. Saving power in nonvolatile storage devices such as spinning disks reduces cost and waste, lengthens device lifespan, and better-protects data. However, infrastructure cost must still be provisioned to handle the full array of hard disk drives when spinning at peak performance.

There is a need in the art for improving power efficiency and endurance of large storage systems which utilize hard disk drives.

### SUMMARY OF THE CLAIMED INVENTION

The present invention may utilize a maximum power consumption threshold to constrain power consumed by a plurality of devices. A power consumption threshold may be selected for a data storage system having multiple drives. Policies may control operation of storage devices such as hard disk drives to ensure the power consumption threshold is not exceeded. The policies may implement procedures for on-demand or scheduling of hard disk drive operations based on access demand, disk drive power characteristics, scheduling maintenance tasks, managing device power states, and strategically scheduling device operations based on their current state. The policies may be implemented by a data manager application in communication with multiple tiers of a data storage system.

### BRIEF DESCRIPTION OF THE DRAWINGS

FIG. 1 is a block diagram of a system for managing power consumption of a storage system.

FIG. 2 is a method for managing disk drives based on power consumption thresholds.

FIG. 3 is a method for controlling disk drive activity based on drive power characteristics.

FIG. 4 is a method for transitioning a disk drive power state.

FIG. 5 is a method for managing disk drive power activity based on maintenance power consumption.

FIG. 6 is a block diagram of a computing device for implementing the present technology.

### DETAILED DESCRIPTION

A power consumption threshold is managed by a data management application to keep total power consumption below the threshold. The data management application may implement set policies to manage power consumed by a plurality of devices. The threshold may be selected for a data storage system having multiple drives. The policies may control operation of storage devices such as hard disk drives to ensure the power consumption threshold is not exceeded. The policies may be used to implement procedures for scheduling hard disk drive operations based on disk drive power characteristics, scheduling maintenance tasks, managing device power states, and strategically scheduling device operations based on their current state.

FIG. 1 is a block diagram for providing a data storage system. The system of FIG. 1 includes computing devices 110 and 120, network attached storage (NAS) 130, storage area network (SAN) 140, primary hard disk drive storage 150, a massive array of idle disks (MAID) storage 170, and data manager 160. Computing devices 110-120, NAS 130, and SAN 140 may communicate over CIFS, NFS, and block protocols. Devices 110-140 may represent host devices or systems which provide data to be stored in the data storage systems provided by devices and systems 150-170. Additional hosts may be used with the present invention.

Devices 110-140 may store data in primary storage 150 and MAID storage 170. In embodiments, MAID storage 170 may be directly accessed by devices 110-140, without an intervening HDD device such as HDD storage 150. Data manager 160 may control data stored from hosts 110-140. Data manager may implement policies associated with the data and corresponding host to determine how the data should be stored and subsequently maintained. In an embodiment, application 165 on data manager 160 may apply set policies to manage data stored on primary storage 150 and MAID storage 170. The primary tier of primary HDD storage 150 and secondary tier of MAID storage 170 are intended to be exemplary. The present invention may be used with additional tiers, including tape storage tiers, and with primary, secondary and other tiers having multiple storage device types and systems, including solid state drives and cloud storage systems.

Application 165 may implement one or more policies for conserving power in the data storage system illustrated in FIG. 1. In some embodiments, the strategies and policies for conserving power in a hard disk drive system may be applied to primary hard disk drive storage system 150, MAID storage system 170, or both. Application may control disk operation, manage power states, control maintenance performed for the disk devices, and other functionality related to power. A discussion of some exemplary policies implemented by application 165 is discussed with reference to FIGS. 2-5. Though the policies are discussed for disk devices with spinning disks, many of the policies discussed herein may be applied to other storage device types as well.

The system of the present invention may mange many features regarding storage device power state. For example, the present technology may manage queuing of requests, controlling power consumed during spin-up, on-demand power-on, spin-up and activation for servicing requests. The system may also handle other power-on responses to requests to comply with the power threshold. For example, storage devices are off until there is activity to turn them on, they may be used, and then return to their natural sleep state. This is opposed to disk devices which are constantly on, unless power is capped, dynamically forcing the least used of these devices to power off second-by-second. The present system of the invention may also schedule time of day changes to power, or time of day scheduling changes to policies which manager device power states.

FIG. 2 is a method for managing disk drives based on a power consumption threshold. First, a power consumption threshold is selected as a consumption level at or below normal operating power consumption at step 210. The power consumption threshold may be well below the maximum power or peak power consumption at which the disk drive system could operate. The power consumption threshold may be selected at some level below a normal operating threshold. For example, the power consumption threshold may be set at 70% of the average power consumption over a period of time, such as one day, a week, or other period of time. In some embodiments, the power consumption threshold may transition from full power through a continuum of power caps down to a very low cap, such as for example less than twenty-five percent of normal operating power.

Storage devices which may make-up MAID and other storage devices may have their power level controlled based on requested or desired activity, hard disk drive power characteristics, and the selected power consumption threshold at step 220. The disk drive activity may be based on history, recent events, expected behaviors, or other activity. Controlling disk drive power level based on disk drive power characteristics and the selected power consumption threshold is discussed in more detail below with respect to the method of FIG. 3. Disk drive activity may also be affected by setting a hard disk drive in a particular power state. Managing hard disk drive power states is discussed in more detail with respect to the method of FIG. 4.

Maintenance tasks may be scheduled based at least in part on the selected power consumption threshold at step 230. In some embodiments, once the power consumption threshold is selected, a portion of the total allowed power consumption may be allocated for maintenance tasks. Maintenance tasks may then be scheduled such that the power consumed for maintenance tasks is within the allocated power consumption. Further, the maintenance task power consumption when combined with current hard disk drive power consumed will not violate the power consumption threshold. Scheduling maintenance tasks is discussed in more detail below with respect to the method of FIG. 5.

In should be understood in the art that maintenance tasks may be preempted by other activity, such as data read and write operations, and vice versa—other activities may be preempted by maintenance tasks. The techniques discussed herein are intended to be flexible.

FIG. 3 is a method for controlling disk drive activities to be serviced based on disk drive power characteristics and power consumption threshold. In some embodiments, the method of FIG. 3 provides more detail for step 220 of the method of FIG. 2. First, power characteristics may be determined for disk drives at step 310. The power characteristics may include the normal power consumption during peak operation, the power required to spin up the device, the power required for specific tasks, and other power characteristics. In some embodiments, if a set of drives is commonly brought up, powered down and transitioned between power states together, the power characteristics may be determined for that group of drives rather than individually, or in addition to the individual drive characteristics.

Requests to be serviced are detected by disk drives at step 320. These requests may be for reading data, writing data, or other tasks. A service schedule is generated for the requests based on disk drive power characteristics and the power consumption threshold at step 330. As long as “schedule” is not about the clock, but could be about demand-based queuing.

The servicing schedule is generated such that the requests will be serviced while maintaining a power consumption that satisfies the power consumption threshold based on the power characteristics of the device. For example, if one hundred requests are received in a certain period, and servicing more than fifty requests at a time would drive the power consumption to violate the power consumption threshold, the requests would be scheduled equitably in smaller batches that would not violate the threshold. In some embodiments, the priority of the service requests may be considered or dynamically modified in scheduling service of requests, in addition to other policy considerations.

FIG. 4 is a method for transitioning a disk drive power state. First, a current power state for a disk is identified at step 410. For example, if a disk just stopped a read or write operation, the disk drive may be in a full power on state. Other hard disk drive states may include a low power state, a hibernation state, a power off state, a head down state, and other states. Next, a determination is made as to whether the disk drive should transition to a lower state based on disk drive policy at step 420. As long as “lower power state” includes “off” as one option. Also note, it involves moving drives to higher power state to service requests.

For example, a policy may indicate that a disk should transition from a power on state to a hibernation state if it is has been idle for more than 20 minutes (or 20 seconds). If a particular drive has been idle for more than 20 minutes (or 20 seconds), then that drive would transition to a lower power state based on disk drive policy at step 420.

If a drive is determined not to transition to a lower power state based on hard disk drive policy, a determination is made as to whether the disk drive should be transitioned to a lower state based on the device's recent activity. If a drive has been active for a considerable period of time, but other drives need to be powered up, the current drive may be transitioned to a lower power state and maintained there for at least a minimum period of time. If the drive is not to be transitioned to a lower state based on recent activity, a determination is made at step 440 if the drive should be transitioned to a lower state based on historic activity patterns at step 440. If there is a history of the drive being active within a certain interval or scheduled period of time, such as for example during morning business hours, that drive may not be transitioned to a lower power state during that time. However if a time period is about to begin where a drive is historically and reliably not used, such as for example during after business hours, the drive may be transitioned to a lower power state at step 440. If at step 440 the hard drive is not transitioned to a lower power state, the drive is not transitioned at step 450. Otherwise, the disk drive is transitioned to a lower power state at step 460.

FIG. 5 is a method for managing disk drive power activity based on maintenance power consumption. First, a level of power consumption to allow for maintenance tasks at a hard drive is determined at step 510. The power consumption may be determined for maintenance tasks such as health checks, maintenance checks, and other housekeeping tasks performed by a hard disk drive or a system comprised of drives. The power consumption to allow for servicing requests is determined based on the power consumption threshold and the maintenance power consumption at step 520. Hence, once the power consumption to allow for maintenance tasks is determined, the power consumption to allow for servicing requests is reduced by that amount from the overall power consumption threshold. Disk drive requests servicing is then scheduled based on the power consumption threshold and the maintenance power consumption at step 530. Once the total power consumption is known for allocating to servicing disk requests, servicing of those disk requests can be scheduled. Disk drive servicing will be scheduled such that the overall power consumption of the disk system does not exceed the power consumption threshold. Scheduling of maintenance tasks may be completed to ensure that the power consumption allocated to maintenance tasks does not exceed the allocated power consumption for maintenance related operations. In some embodiments some portion of, or all maintenance tasks may sometimes be made higher priority than servicing requests (eg. during critical recovery operations).

FIG. 6 illustrates an exemplary computing system 600 that may be used to implement a computing device for use with the present technology. System 600 of FIG. 6 may be implemented in the contexts of the likes computing device 110, 120, devices making up NAS 130 and SAN 140, and data manger 160. The computing system 600 of FIG. 6 includes one or more processors 610 and memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a floppy disk, compact disk or Digital video disk, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for automatically managing power in a system of storage devices, comprising:
selecting a power consumption threshold not be exceeded by the storage devices system, the selected power threshold at or less than the normal power consumption of the system of storage devices;
controlling storage device power level power level based on storage device power characteristics and the selected power consumption threshold; and
scheduling maintenance tasks based on estimated power consumption and the selected power consumption threshold.

2. The method of claim 1, wherein controlling storage device power level includes controlling power-on and spin-up power level of a plurality of storage devices based on their spin-up power characteristics

3. The method of claim 1, wherein scheduling maintenance tasks includes allocating an amount of power consumption within the selected power consumption threshold to be used for storage device maintenance tasks.

4. The method of claim 1, further comprising scheduling I/O processing by storage devices to consume an amount of power that is less than the sum of the selected power consumption threshold and an allocation of power to be used for storage device maintenance tasks.

5. The method of claim 1, further comprising:
identifying multiple hard storage devices with a queue of requests to service; and
scheduling hard disk servicing based on power consumption of the hard disk.

6. The method of claim 1, further comprising:
determining the power required for each hard storage device to service its requests; and
scheduling the hard storage device service requests such that the selected power threshold is not exceeded.

7. The method of claim 1, wherein the power consumption threshold is less than fifty percent of normal power consumption for the storage device system.

8. The method of claim 1, further comprising transitioning a hard drive to a lower state based on the selected power consumption threshold and at least one of policy, hard drive recent power level, and historic power level pattern.

9. A computer readable non-transitory storage medium having embodied thereon a program, the program being executable by a processor to perform a method for automatically managing power in a system of storage devices, the method comprising:
selecting a power consumption threshold not be exceeded by the storage device system, the selected power threshold at or less than the normal power consumption of the system of storage devices;
controlling storage device power level based on storage device power characteristics and the selected power consumption threshold; and
scheduling maintenance tasks based on estimated power consumption and the selected power consumption threshold.

10. The computer readable non-transitory storage medium of claim 9, wherein controlling storage device power level includes controlling spin-up power level of a plurality of storage devices based on their spin-up power characteristics

11. The computer readable non-transitory storage medium of claim 9, wherein scheduling maintenance tasks includes allocating an amount of power consumption within the selected power consumption threshold to be used for storage device maintenance tasks.

12. The computer readable non-transitory storage medium of claim 9, further comprising scheduling I/O processing by storage devices to consume an amount of power that is less than the sum of the selected power consumption threshold and an allocation of power to be used for storage device maintenance tasks.

13. The computer readable non-transitory storage medium of claim 9, further comprising:
identifying multiple hard storage devices with a queue of requests to service; and
scheduling hard disk servicing based on power consumption of the hard disk.

14. The computer readable non-transitory storage medium of claim 9, further comprising:
determining the power required for each hard storage device to service its requests; and
scheduling the hard storage device service requests such that the selected power threshold is not exceeded.

15. The computer readable non-transitory storage medium of claim 9, wherein the power consumption threshold is less than fifty percent of normal power consumption for the storage device system.

16. The computer readable non-transitory storage medium of claim 9, further comprising transitioning a hard drive to a lower state based on the selected power consumption threshold and at least one of policy, hard drive recent power level, and historic power level pattern.

17. A data storage system, comprising;
a storage system having a plurality of hard drives;
a data manager in communication with the hard drives and having a processor, memory and one or more modules stored in memory, the one or more modules executable by the processor to:
select a power consumption threshold not be exceeded by the storage device system, the selected power threshold at or less than the normal power consumption of the system of storage devices;
control storage device power level based on storage device power characteristics and the selected power consumption threshold; and
schedule maintenance tasks based on estimated power consumption and the selected power consumption threshold.
